(19) United States
(12) Patent Application Publication
(10) Pub. No.: US 2005/0047616 A1
(43) Pub. Date: Mar. 3, 2005

(54) Flat panel monitor frame with integral speakers

(76) Inventor: Noel Lee, Las Vegas, NV (US)

Correspondence Address: LaRiviere, Grubman & Payne, LLP, P.O. Box 3140, Monterey, CA, 93942, US

(21) Appl. No.: 10/655,494

(22) Filed: Sep. 3, 2003

(51) Int. Cl. H04R 25/00; H04R 9/06; H04R 11/02

(52) U.S. Cl. 381/152; 381/306; 381/333; 381/431

(57) ABSTRACT

A flat panel monitor frame with integrated speakers provides an esthetic visual effect and enhanced acoustic experience for a flat panel monitor. The flat panel monitor frame seamlessly blends the otherwise cold appearance of the flat panel monitor into a room decor, and includes user detachable and replaceable trim pieces to facilitate blending the flat panel monitor into the room decor. The flat panel monitor frame further includes an array of speakers along at least one frame side. The speakers thus provided may reduce the need for additional floor or wall mounted speakers.

### TECHNICAL FIELD

The present invention relates to a mounting frame for a flat panel monitor, and more particularly to a flat panel monitor frame including integral speakers. The monitor frame is particularly well suited for residential use, or use in any surroundings where an opulent or furniture like appearance is desired.

### BACKGROUND ART

Flat panel monitors, or flat panel television sets, for example, plasma monitors or Liquid Crystal Display (LCD) monitors, are become increasingly popular for residential use. Such monitors provide very high quality pictures, and a fit within an envelop only slightly larger than the screen itself. The small envelop allows flat panel monitors to be used in many locations were a conventional television would require too much space or would detract from the overall ambiance of the room. Unfortunately, known flat panel monitors have a harsh appearance that does not fit well within many home decorating schemes. Further, additional speakers are often required to enhance the sound experience associated with visual entertainment (i.e., multi-channel sound), and such speakers may not fit well into the home decorating scheme. Accordingly, there is a need for a method and/or apparatus to soften the appearance of flat panel monitors, while providing additional speakers.

### DISCLOSURE OF INVENTION

The present invention addresses the above and other needs by providing a flat panel monitor frame with integrated speakers, creating an esthetic visual effect and enhanced acoustic experience for a wall mounted or table supported flat panel monitor. The flat panel monitor frame seamlessly blends the otherwise cold appearance of the flat panel monitor into a room decor and includes user detachable and replaceable trim pieces to facilitate blending the flat panel monitor into the room decor. The flat panel monitor frame further includes an array of speakers along at least one frame side. The speakers thus provided may reduce the need for additional floor or wall mounted speakers. In a preferred embodiment, the flat panel monitor frame is sized to accept up to a 50 inch flat panel monitor.

In accordance with one aspect of the invention, there is provided a flat panel monitor frame including frame sections suitable for bordering a flat panel monitor, the frame sections comprising: a frame top; a frame right side extending downward from the frame top; and a frame left side extending downward from the frame top. The frame sections are preferably made from aluminum, and more preferably from extruded aluminum. The flat panel monitor frame further includes at least one speaker residing in the sections, and means for electrically connecting the speaker to a source of at least one speaker signal associated with the flat panel monitor. The speaker signal may be from the flat panel monitor, or be a signal associated with video displayed on the flat panel monitor, which speaker signal that has been amplified and/or processed by an Audio/Video (AV) sound processor, an AV receiver, a stereo receiver, or the like, and then provided to the speakers in the flat panel monitor frame.

The flat panel monitor frame may further include speakers in the frame right side, the frame left side, the frame top, and when the flat panel monitor frame sections include a frame bottom, the frame bottom. The speakers may be high frequency speakers (commonly called “tweeters”,) or may be mid range speakers. The speakers may be mounted directly to the metal frame sections, or to baffles residing within the frame sections, which baffles are preferably constructed from wood, and more preferably from Medium Density Fiberboard (MDF). The flat panel monitor frame may further include electrical circuits for filtering speaker signals (commonly called low pass filter, a band-pass filters or cross-over networks) which electrical circuits may reside on Printed Circuit Boards (PCBs). The flat panel monitor frame may further include one or more Audio Video (AV) components such as a power conditioner, AV sound processor, an AV receiver, a stereo receiver, a AV pre-amplifier, one or more power amplifiers, or the like. The signals from the AV components may be provided to speakers residing in the flat panel monitor frame, or to additional speakers mounted apart from the flat panel monitor frame. The speakers may be covered by removable grills, and other portions of the flat panel monitor frame may be covered by removable trim. The flat panel monitor frame may further include a back support board, which back support board may be preferably made from wood, and more preferably from MDF. The flat panel monitor is preferably mounted through the back support board using standard mounting brackets (i.e. manufacturer supplied mounting brackets, or third party mounting brackets.)

It is feature of the present invention to provide an embodiment of a frame system for a flat panel monitor, said frame system having a frame comprising: a frame top; a frame bottom; a frame right side connected between the frame top and the frame bottom; and a frame left side connected between the frame top and the frame bottom. The frame system may further include a back support board attached to said frame, said back support board suitable for supporting the flat panel monitor, and speakers residing in said speaker portion of said frame. In-view surfaces of the frame include a speaker portion and a trim portion. The speaker portion may be covered by removable and replaceable grills and the trim portion may be covered by removable and replaceable trim to better match the appearance of the flat panel monitor frame to the room decor.

It is a further feature of the invention to provide a speaker and frame system for a flat panel monitor, including a frame comprising: a frame top; a frame bottom; a frame right side connected between the frame top and the frame bottom; and a frame left side connected between the frame top and the frame bottom. Said frame right side may house a multiplicity of right speakers, said frame left side may house a multiplicity of left speakers, and the frame top may house a multiplicity of top speakers.

### BRIEF DESCRIPTION OF THE DRAWINGS

The above and other aspects, features and advantages of the present invention will be more apparent from the following more particular description thereof, presented in conjunction with the following drawings wherein:

FIG. 1 shows a flat panel monitor frame according to the present invention;

FIG. 2 depicts a flat panel monitor displaying a scene in the flat panel monitor frame of FIG. 1;

FIG. 3A shows a cross-sectional view of the flat panel monitor in the flat panel monitor frame, taken along line 2A-2A of FIG. 2, including a back support board;

FIG. 3B depicts an alternative embodiment cross-sectional view of the flat panel monitor frame, taken along line 2A-2A of FIG. 2, wherein the flat panel monitor is mounted to a vertical surface, and the flat panel monitor frame is mounted over the monitor;

FIG. 4 depicts a detailed cross-sectional view of an example of a frame top portion of the flat panel monitor frame taken along line 1A-1A of FIG. 1, wherein a speaker is shown housed in the frame top;

FIG. 5 shows a multiplicity of speakers mounted in the speaker top, and an electrical circuit for filter a speaker signal for the speakers;

FIG. 6 depicts a multiplicity of speakers mounted in a speaker right side;

FIG. 7 depicts speaker terminals mounted in a speaker bottom;

FIG. 8 shows an example of a flat panel monitor frame with grill removed to show an example of a speaker arrangement;

FIG. 9 shows a second embodiment of a flat panel monitor frame adapted to rest on a table top; and

FIG. 10 depicts a flat panel monitor in the flat panel monitor frame of FIG. 9.

Corresponding reference characters indicate corresponding components throughout the several views of the drawings.

### MODES FOR CARRYING OUT THE INVENTION

The following description is of the best mode presently contemplated for carrying out the invention. This description is not to be taken in a limiting sense, but is made merely for the purpose of describing a preferred embodiment of the invention. The scope of the invention should be determined with reference to the claims.

The present invention provides a flat panel monitor frame with integrated speakers. The flat panel monitor frame seamlessly blends the otherwise cold appearance of the flat panel monitor into a room decor, and includes user detachable and replaceable trim pieces to facilitate blending the flat panel monitor into the room decor. The flat panel monitor frame further includes speakers residing in at least one frame section.

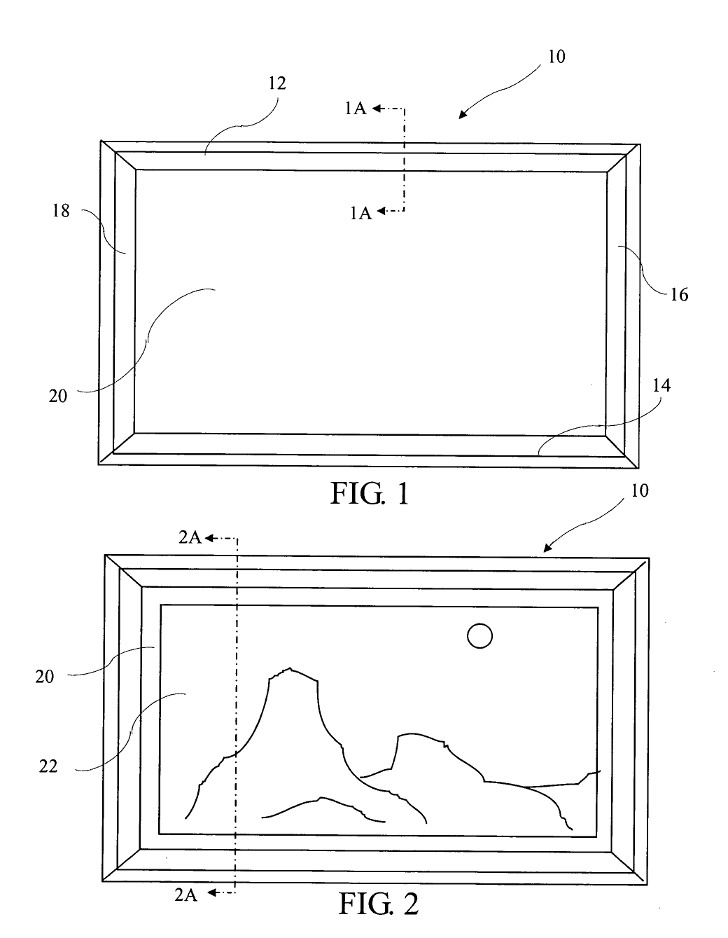

A flat panel monitor frame 10 is shown in FIG. 1. The frame perimeter is formed of frame sections include a frame top 12, a frame bottom 14, a frame right side 16, and a frame left side 18. The frame sections are preferably constructed from aluminum, and more preferably from extruded aluminum. A back support board 20 is attached to the back of the frame sections. The back support board 20 is preferably made from a wood material, and more preferably from Medium Density Fiberboard (MDF). The flat panel monitor frame 10 with a flat panel monitor 22 mounted in shown in FIG. 2.

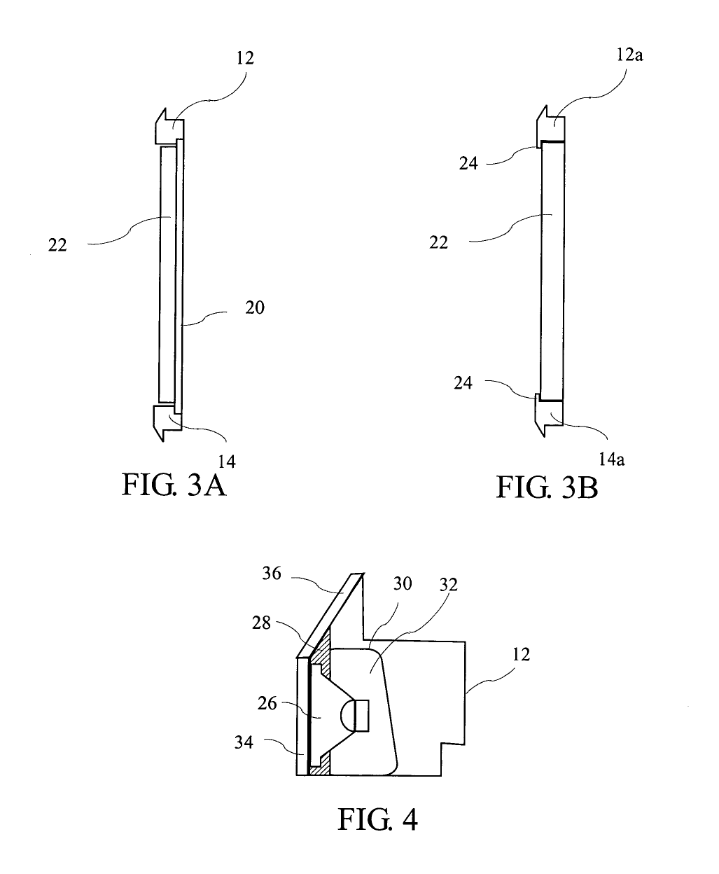

A cross-sectional view of the flat panel monitor frame 10 with flat panel monitor 22 mounted, taken along line 2A-2A of FIG. 2 is shown in FIG. 3A. Back support board 20 is attached to the frame sections. The flat screen monitor 22 is preferably supported using standard mounting brackets, for example manufacturer supplied mounting brackets, or other third party brackets. The back support board 20 may be provided opening suitable for standard support brackets, or openings may be created in the back support board 20 suitable for standard support brackets.

A cross-section taken along line 2A-2A of FIG. 2 is shown in FIG. 3B wherein an alternative flat panel monitor frame 10 is mounted over the flat panel monitor 22. The alternative flat panel monitor frame 10 includes second frame top 12a and frame bottom 14a having a flange 24 which extends inwardly over the front of the flat panel monitor 22 to provide a more finished appearance.

An example of a cross-section of the frame top 12 taken along line 1A-1A of FIG. 1 is shown in FIG. 4. The profile of the cross-section is for example only, and various profiles are intended to come within the scope of the present invention. The cross-section shows a speaker 26 mounted to a baffle 28, but the speaker 26 also may be mounted directly to the frame section the speaker 26 resides in. The speaker may be a high frequency speaker (also called a tweeter), or a midrange frequency speaker. Baffle 28 is preferably constructed from a wood material, and more preferably from MDF. Speaker 26 may be enclosed by speaker enclose 30, thereby creating speaker volume 32. The front (e.g., visible or exposed) surface of the frame top 12 defines a speaker portion over the speaker, and a remaining portion hereafter called a trim portion. A grill 34 resides over the speaker portion. The grill is preferably removable and replaceable, wherein different appearance may be obtained by using different grills. The grill may be cloth covered (i.e., by grill cloth), or may be metal covered, or may be a thin sheet of metal. In one embodiment, the grill is made from arced perforated aluminum. Removable replaceable trim 36 resides over the trim portion, and the trim 36 may be selected to provide a desired appearance.

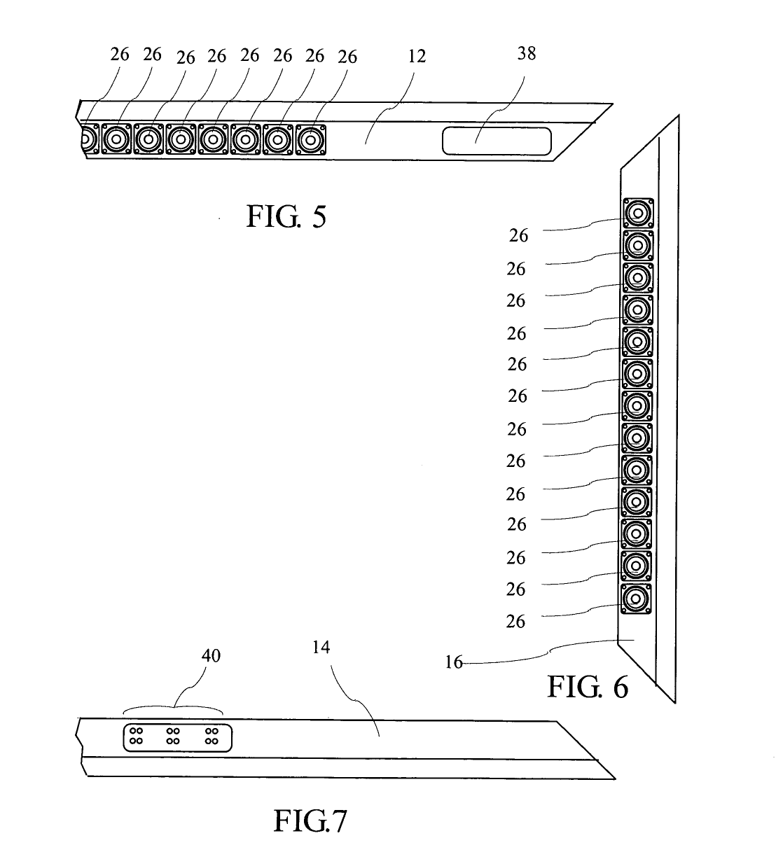

A portion of the frame top 12 is shown in FIG. 5. A multiplicity of speakers 26 are shown in a row configuration. The speakers 26 may be high frequency or midrange speakers, or a mix of high frequency and midrange speakers. Although a single row of speakers 26 is shown, other embodiments may include two or more rows of speakers 26, with high frequency speakers and midrange speakers in the same row or in different rows, and the speakers may be pointed in different directions. An electronic circuit 38 may also be housed in the frame top 12. The circuit 38 is typically a band-pass filter designed to pass a speaker signal comprising a band of frequencies suitable for the speakers 26. If both high frequency and mid range speakers are present, the circuit 38 may provide two or more outputs matched to groups of speakers. Such circuits are commonly know as a cross-over network.

Additionally, the circuit 38 may include power conditioning (e.g., surge protection) and Audio/Visual (A/V) processing. For example, the circuit 38 may include one or more of dts® 96/24 Decoding, dts®-ES Discrete 6.1 Decoding, dts® NEO 6: Music & Cinema Surround Decoding, Dolby® Digital EX 6.1 Surround Decoding, Dolby® Pro Logic II Music & Movie Surround Decoding, and THX surround EX Decoding. The circuit 38 may include tuner functions, pre-amplifier functions, and power amplifier functions, and be capable of selecting input signals from a multiplicity of sources including antenna, cable, DVD, VCR, and the like. The circuit 38 may further include functions to display control information on the flat screen monitor, and to receive remote control commands.

An embodiment of frame right side 16 is shown in FIG. 6. A multiplicity of speakers 26 are arrange in a single column. The speakers 26 may be high frequency speakers, midrange speakers, or a combination of high frequency speakers and midrange speakers. Other embodiments may include two or more columns of speakers 26, with high frequency speakers and midrange speakers in the same column or in different columns, and the speakers may be pointed in different directions. A separate circuit 38 may be housed in the frame right side 16 to provide at least one speaker signal, speaker signal maybe provided to the speakers 26 directly, or speaker signals may be provided through a circuit housed in another part of the flat panel monitor frame 10. The circuit 38 residing in the frame right side 16 may further provide any of the functions described for the circuit 38 in FIG. 5 above.

An embodiment of frame bottom 14 is shown in FIG. 7. The frame bottom 14 may include speaker terminal 40. The terminals 40 are preferably on the back side of the frame bottom 14, out of view. The terminals 40 may comprise a single pair of terminals for one channel of sound, two pairs of terminals for right and left channels of sound, or three pairs of terminals for right, left and center channels of sound. The terminals 40 may also comprise two pairs for each channel to allow bi-wiring. The frame bottom 14 may alternatively include speakers 26 and/or circuit 38 as described in FIG. 5 for the frame top 12.

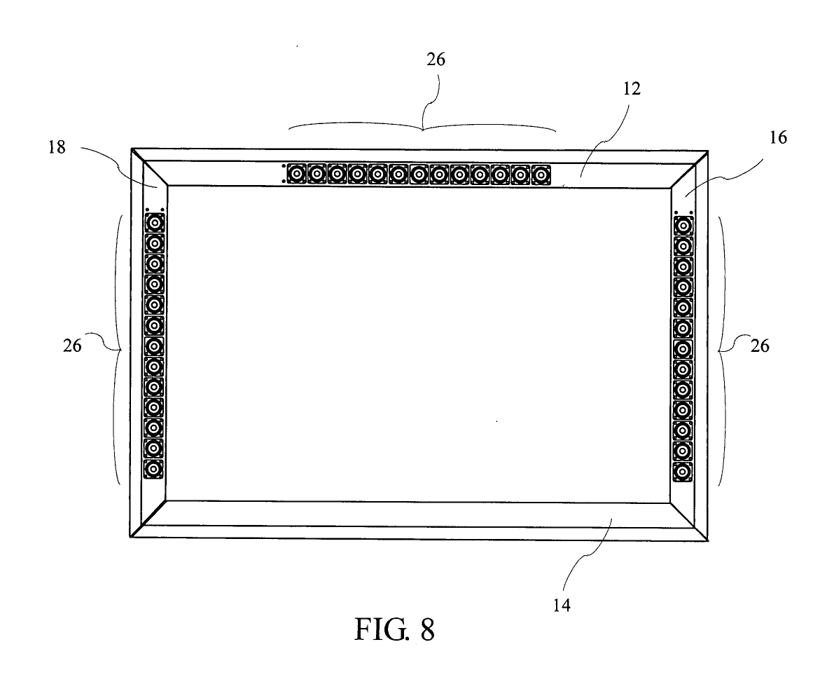

An example of a combination of the frame sections shown in FIGS. 5, 6, and 7 is shown in FIG. 8. In this example, a multiplicity of speakers 26 are shown in the frame top 12, the frame right side 16, and the frame left side 18. The speakers maybe high frequency speakers, midrange speakers, or a combination of high frequency and midrange speakers. Speakers 26 may alternatively reside in the frame bottom 14 in place of, or in addition to the speakers in the frame top 12. The number of speakers 26 residing in each frame section is preferably 13, but may vary based on parameters including speaker size, frame size, desired audio performance, cost, or the like.

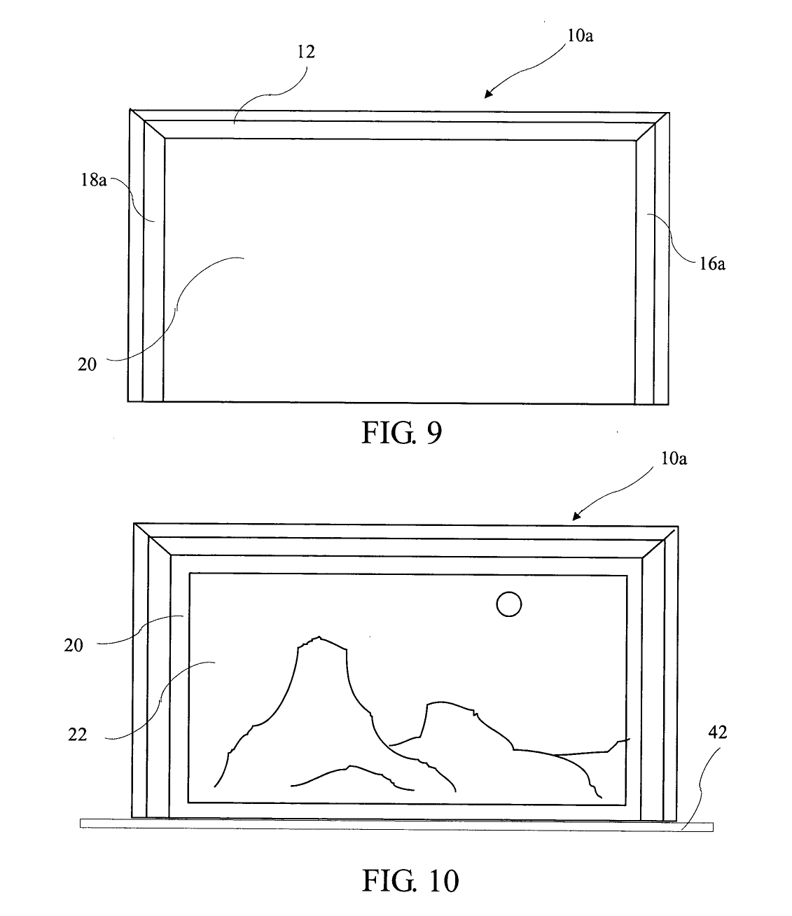

A second flat panel monitor frame 10a is shown in FIG. 8. The flat monitor frame 10a is adapted to cooperate with a flat panel monitor 20 supported on a table top, or on any horizontal surface. The flat panel monitor frame 10a includes the frame top 12, a second fame rights side 16a, and a second frame left side 18a. The flat panel monitor 22 and the flat panel monitor frame 10a are shown resting on a table 42 in FIG. 9. The flat panel monitor 22 and the flat panel monitor frame 10a may similarly rest on any suitable horizontal surface, for example a shelf or the like.

While the invention herein disclosed has been described by means of specific embodiments and applications thereof, numerous modifications and variations could be made thereto by those skilled in the art without departing from the scope of the invention set forth in the claims.

Information as herein shown and described in detail is fully capable of attaining the above-described object of the invention, the present preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, one skilled in the art should recognize that various changes and modifications in form and material details may be made without departing from the spirit and scope of the inventiveness as set forth in the appended claims. No claim herein is to be construed under the provisions of 35 U.S.C. § 112, sixth paragraph, unless the element is expressly recited using the phrase “means for.”

1. A flat panel monitor frame comprising:
frame sections suitable for bordering a flat panel monitor, comprising:
a frame top;
a frame right side extending downward from the frame top; and
a frame left side extending downward from the frame top;
at least one speaker residing in at least one of the frame sections; and
means for electrically connecting the at least one speaker to a source of at least one speaker signal associated with the flat panel monitor.

2. The flat panel monitor frame of claim 1 wherein said at least one speaker comprises at least one speaker mounted in the frame right side and at least one speaker mounted in the frame left side.

3. The flat panel monitor frame of claim 2 wherein said at least one speaker mounted in the frame right side and said at least one speaker mounted in the frame left side comprise a multiplicity of speakers mounted in the frame right side and a multiplicity of speakers mounted in the frame left side.

4. The flat panel monitor frame of claim 3 further including a plurality of speakers mounted in at least one of the frame top and the frame bottom.

5. The flat panel monitor frame of claim 4 wherein said speakers are high frequency speakers.

6. The flat panel monitor frame of claim 4 wherein said speakers include high frequency speakers and mid-range speakers.

7. The flat panel monitor frame of claim 4 further including removable grills over the speaker.

8. The flat panel monitor frame of claim 1 wherein said at least one speaker is mounted in a wood material baffle.

9. The flat panel monitor frame of claim 1 wherein at least one of a group consisting of a power conditioner, an Audio/Video (AV) sound processor, an AV receiver, a stereo receiver, a AV pre-amplifier, and one or more power amplifiers, reside in at least one of the frame sections.

10. The flat panel monitor frame of claim 1 wherein said frame sections are made from aluminum.

11. The flat panel monitor frame of claim 1 wherein said frame sections are made from extruded aluminum.

12. The flat panel monitor frame of claim 1 further including a back support board.

13. The flat panel monitor frame of claim 12 wherein said back support board is constructed from MDF.

14. The flat panel monitor frame of claim 1 further including at least one electrical circuit to process the speaker signal.

15. The flat panel monitor frame of claim 14 wherein said at least one electrical circuit resides on a Printed Circuit Board (PCB).

16. The flat panel monitor frame of claim 1 further including removable replaceable trim.

17. The flat panel monitor frame of claim 14 wherein said removable replaceable trim is made from wood.

18. A frame system for a flat panel monitor, comprising:
a frame including a speaker portion and a trim portion, said frame comprising:
a frame top;
a frame right side extending downward from the frame top; and
a frame left side extending downward from the frame top;
a back support board attached to said frame;
speakers residing in said speaker portion of said frame,
removable and replaceable grills residing over said speaker portion; and
removable and replaceable trim residing over said trim portion.

19. A speaker and frame system for a flat panel monitor, comprising:
a frame comprising:
a frame top;
a frame bottom;
a frame right side connected between the frame top and the frame bottom; and
a frame left side connected between the frame top and the frame bottom;
a multiplicity of speakers housed in said frame right side;
a multiplicity of said speakers housed in said frame left side; and
a multiplicity of said speakers housed in said frame top.

20. The system of claim 19, further including at least one circuit for processing speaker signals for said speakers.
